(19) United States
(12) Patent Application Publication
(10) Pub. No.: US 2005/0163691 A1
(43) Pub. Date: Jul. 28, 2005

(54) NOx reduction composition for use in FCC processes

(76) Inventors: C.P. Kelkar, Bridgewater, NJ (US); David M. Stockwell, Westfield, NJ (US); Samuel J. Tauster, Manalapan, NJ (US)

Correspondence Address: ENGELHARD CORPORATION, 101 WOOD AVENUE, ISELIN, NJ, 08830, US

(21) Appl. No.: 10/763,812

(22) Filed: Jan. 23, 2004

(51) Int. Cl. C10G 11/00; B01J 23/10

(52) U.S. Cl. 423/239.1; 208/113; 208/120.01; 208/120.1; 502/304

(57) ABSTRACT

A composition for controlling NOₓ emissions during FCC processes comprises a mixed oxide of ceria and zirconia, (ii) optionally, at least one oxide from the lanthanide series other than ceria and (iii) optionally, an oxide of a metal from Groups Ib and IIb such as copper, silver and zinc.

### BACKGROUND OF THE INVENTION

A major industrial problem involves the development of efficient methods for reducing the concentration of air pollutants, such as carbon monoxide, sulfur oxides and nitrogen oxides in waste gas streams which result from the processing and combustion of sulfur, carbon and nitrogen containing fuels. The discharge of these waste gas streams into the atmosphere is environmentally undesirable at the sulfur oxide, carbon monoxide and nitrogen oxide concentrations that are frequently encountered in conventional operations. The regeneration of cracking catalyst, which has been deactivated by coke deposits in the catalytic cracking of sulfur and nitrogen containing hydrocarbon feedstocks, is a typical example of a process which can result in a waste gas stream containing relatively high levels of carbon monoxide, sulfur and nitrogen oxides.

Catalytic cracking of heavy petroleum fractions is one of the major refining operations employed in the conversion of crude petroleum oils to useful products such as the fuels utilized by internal combustion engines. In fluidized catalytic cracking processes, high molecular weight hydrocarbon liquids and vapors are contacted with hot, finely-divided, solid catalyst particles, either in a fluidized bed reactor or in an elongated transfer line reactor, and maintained at an elevated temperature in a fluidized or dispersed state for a period of time sufficient to effect the desired degree of cracking to lower molecular weight hydrocarbons of the kind typically present in motor gasoline and distillate fuels.

In the catalytic cracking of hydrocarbons, some nonvolatile carbonaceous material or coke is deposited on the catalyst particles. Coke comprises highly condensed aromatic hydrocarbons and generally contains from about 4 to about 10 weight percent hydrogen. When the hydrocarbon feedstock contains organic sulfur and nitrogen compounds, the coke also contains sulfur and nitrogen. As coke accumulates on the cracking catalyst, the activity of the catalyst for cracking and the selectivity of the catalyst for producing gasoline blending stocks diminishes.

The catalyst which has become substantially deactivated through the deposit of coke is continuously withdrawn from the reaction zone. This deactivated catalyst is conveyed to a stripping zone where volatile deposits are removed with an inert gas at elevated temperatures. The catalyst particles are then reactivated to essentially their original capabilities by substantial removal of the coke deposits in a suitable regeneration process. Regenerated catalyst is then continuously returned to the reaction zone to repeat the cycle.

Catalyst regeneration is accomplished by burning the coke deposits from the catalyst surfaces with an oxygen containing gas such as air. The combustion of these coke deposits can be regarded, in a simplified manner, as the oxidation of carbon and the products are carbon monoxide and carbon dioxide.

When sulfur and nitrogen containing feedstocks are utilized in catalytic cracking process, the coke deposited on the catalyst contains sulfur and nitrogen. During regeneration of coked deactivated catalyst, the coke is burned from the catalyst surface that then results in the conversion of sulfur to sulfur oxides and nitrogen to nitrogen oxides.

The conditions experienced by the catalyst in a fluid catalytic cracking (FCC) unit are very severe. Catalyst is continuously being cycled between reductive atmosphere on the reactor side to an oxidative atmosphere on the regenerator side. The temperatures between the two zones are different so the catalyst experiences thermal shocks. Also the regenerator contains nominally about 15-25% steam. All these factors lead to a significant decline in the catalyst activity and fresh catalyst needs to be continuously added to maintain the cracking activity.

Various approaches have been used to either reduce the formation of noxious gases or treat them after they are formed. Most typically, additives have been used either as an integral part of the FCC catalyst particles or as separate particles in admixture with the FCC catalyst.

The additive that has gained the widest acceptance for lowering sulfur oxide emissions to date in FCC units (FCCU) is based upon Magnesium oxide/Magnesium aluminate/ceria technology. Pt supported on clay or alumina is most commonly used as an additive for lowering of carbon monoxide emissions. Unfortunately the additives used to control CO emissions typically cause a dramatic increase (e.g. >300%) in NOₓ evolution from the regenerator.

Various approaches have been used to treat nitric oxide gases in FCCU. For example, U.S. Pat. No. 5,037,538 describes the reduction of oxides of nitrogen (NOx) emissions from an FCC regenerator by adding a deNOx catalyst to the FCC regenerator in a form whereby the deNOx catalyst remains segregated within the FCC regenerator.

U.S. Pat. No. 5,085,762 describes the reduction of emissions of noxious nitrogen oxides with the flue gas from the regenerator of a fluid catalytic cracking plant by incorporating into the circulating inventory of cracking catalyst separate additive particles that contain a copper-loaded zeolite material having a characteristic structure with a defined X-ray diffraction pattern.

U.S. Pat. No. 5,002,654 describes a process for regeneration of cracking catalyst while minimizing NOx emissions using a zinc-based deNOx catalyst.

U.S. Pat. No. 5,021,146 describes a process for regeneration of cracking catalyst while minimizing NOx emissions using a Group IIIb based deNOx additive.

U.S. Pat. No. 5,364,517 and U.S. Pat. No. 5,364,517 describe the reduction of the NOx content of FCC regenerator flue gas is reduced using a spinel/perovskite additive.

U.S. Pat. No. 5,750,020 and U.S. Pat. No. 5,591,418 describe process for removing sulfur oxides or nitrogen oxides from a gaseous mixture in an FCC process using a collapsed composition which is substantially composed of microcrystallites collectively of the formula:
M₂ₘ²⁺Al₂₋ₚMₚ³⁺TᵣO₇₊ᵣ₋ₛ
where M²⁺ is a divalent metal, M³⁺ is a trivalent metal, and T is vanadium, tungsten, or molybdenum.

U.S. Pat. No. 6,165,933 describes compositions comprising a component containing (i) an acidic oxide support, (ii) an alkali metal and/or alkaline earth metal or mixtures thereof, (iii) a transition metal oxide having oxygen storage capability, and (iv) palladium; to promote CO combustion in FCC processes while minimizing the formation of NOx.

U.S. Pat. No. 6,129,834 and U.S. Pat. No. 6,143,167 describe compositions comprising a component containing (i) an acidic oxide support, (ii) an alkali metal and/or alkaline earth metal or mixtures thereof, (iii) a transition metal oxide having oxygen storage capability, and (iv) a transition metal selected from Groups Ib and/or IIb of the Periodic Table; to provide NOx control performance in FCC processes.

Copending, commonly assigned U.S. application Ser. No.10/001,485, published as U.S. 20030098259, describes compositions comprising a component containing (i) an acidic oxide support, (ii) ceria, (iii) at least one oxide of the lanthanide series other than ceria and (iv) a transition metal oxide selected from a Group Ib or IIb elements such as Cu and Ag etc. to provide NOx control performance in a FCC processes.

All the additives added to FCC units need to have sufficient hydrothermal stability to withstand the severe environment of an FCCU and there remains the need for NOx additives to be used in FCC that have improved hydrothermal stability.

### SUMMARY OF THE INVENTION

The invention provides novel compositions suitable for use in FCC processes that are capable of providing improved NOₓ control performance.

In one aspect, the invention provides compositions for reducing NOx emissions in FCC processes, the compositions containing a mixed oxide of cerium and zirconium, optionally, with at least one oxide of a rare earth other than cerium. The composition may further contain at least one oxide of a transition metal selected from Groups Ib and IIb of the periodic table. The mixed oxide is preferably spray dried into a microsphere suitable for use in the FCC process with the transition metal oxide either impregnated as a salt of the chosen metal either before or after the formation of the microsphere.

In another aspect, the invention encompasses FCC processes using the NOₓ reduction compositions of this invention either as an integral part of the FCC catalyst particles or as separate particles admixed with the FCC catalyst.

These and other aspects of the invention are described in further detail below.

### DETAILED DESCRIPTION OF THE INVENTION

The invention encompasses the discovery that certain classes of compositions are very effective for the reduction of NOx gas emissions in FCC processes. Moreover, such compositions have unexpectedly improved hydrothermal stability over prior art compositions.

The NOx reduction compositions of the invention are characterized as comprising mixed oxides of cerium and zirconium, optionally with an oxide of an additional rare earth other than cerium. Preferred oxides of additional rare earths other than ceria are the oxides of La, Nd, and Pr. Additionally, at least one transition metal oxide selected from a metal of Group Ib or lib of the periodic table and mixtures thereof can be included in the compositions of this invention. The mixed oxide should contain at least 20 wt % ceria, and at least 15 wt % zirconia. The NOx reducing additive composition will contain at least 20 wt %, typically at least 60 wt % of the ceria-zirconia, and up to about 20% by weight of an oxide of rare earth other than cerium. The NOx reducing additive composition will typically comprise at least 40% by weight, typically at least 55% by weight, of (i), (ii), and (iii).

The mixed oxides of cerium and zirconium with other optional oxides of rare earths have found extensive use in automobile exhaust applications. Examples are described in commonly assigned U.S. Pat. Nos. 4,624,940; 5,057,483; and US Published Patent application 2003/0100447. U.S. Pat. No. 5,057,483 describes that a co-formed rare earth oxide-zirconia composition may be made by any suitable technique such as co-precipitation, co-gelling, or the like. One suitable technique is illustrated in an article by Luccini, E., Mariani, S., and Sbaizero, O. (1989), “Preparation of Zirconia Cerium Carbonate in Water with Urea,” Int. J. of Materials and Product Technology, 4, 167-175, the disclosure of which is incorporated herein. As disclosed starting at page 169 of the article, a dilute (0.1M) distilled water solution of zirconyl chloride and cerium nitrate in proportions to promote a final product of ZrO₂-10 mol % CeO₂ is prepared with ammonium nitrate as a buffer to control pH. The solution was boiled with constant stirring for two hours and complete precipitation was attained with the pH not exceeding 6.5 at any stage.

Other techniques to make mixed oxide formulations of ceria-zirconia with optionally other rare earth oxides are described in U.S. Pat. Nos. 6,528,029; 6,133,194;and 6,576,207, and are incorporated herein by reference.

Any other suitable technique for preparing the co-formed rare earth oxide-zirconia may be employed, provided that the resultant product contains the rare earth oxide thoroughly dispersed and/or in solid solution with the zirconia in the finished product. Thus, for the co-precipitation method described above, the zirconium and cerium (or other rare earth metal) salts may include chlorides, sulfates, nitrates, acetates, etc. The co-precipitates may, after washing, be spray dried to remove water and then calcined in air at about 500° C. to form a co-formed rare earth oxide-zirconia mixed oxide composition.

The Group Ib and/or IIb transition metals may be any metal or combination of metals selected from those groups of the Periodic Table. Preferably, the transition metal is selected from the group consisting of Cu, Ag, Zn, and mixtures thereof. The amount of transition metal present is preferably at least about 100 parts by weight (measured as metal oxide) per million parts of the NOx reductive additive, more preferably from about 0.1 to about 5 parts by weight per 100 parts of the NOx reducing additive.

When the mixed oxide is used in a NOX reducing composition as a separate particle, the oxide can be formed into a microsphere that can be used in a FCC process by conventional means. Thus, the composition of the invention may be combined with fillers (e.g. kaolin, clays, silica-alumina, silica and/or alumina particles) and/or binders (e.g. silica sol, alumina sol, silica alumina sol etc.) to form particles suitable for use in an FCC process, preferably by spray drying and, if needed, subsequent calcination. Preferably, any added binders or fillers used do not significantly adversely affect the performance of the NOx reduction component. The additive particles are preferably of a size suitable for circulation with the catalyst inventory in an FCC process. The microspheres containing the mixed oxide composition are typically 20 to 200 microns and can be effectively used in an FCC process. The additive particles preferably have an attrition characteristics such that they can withstand the severe environment of an FCCU. Microsphere sizes of 50 to 100 microns may be more typical for FCC use.

When the NOx reduction composition is used as an additive particulate (as opposed to being integrated in to the FCC catalyst particles themselves), the amount of NOx reduction component in the additive particles is preferably at least 30 wt %, more preferably at least 55 wt %. It is desired to maximize the amount of NOx reduction actives in the additive particle. However, small amounts of fillers and/or binders are typically needed to form the composition of mixed oxides into microspheres. The amount of cerium oxide (ceria) present in the final formed NOx reduction composition may be varied considerably. Preferably the NOx reduction composition contains at least about 0.5 part by weight of cerium oxide per 100 parts by weight of the final formed additive, more preferably from at least 1 part to about 20 parts by weight of cerium oxide per 100 parts of the final additive composition.

As previously mentioned the NOₓ reduction composition of the invention may be integrated into the FCC catalyst particles themselves. Such catalyst particles will include typically a zeolitic cracking catalyst such as a synthetic faujasite, including zeolite Y or X, or other known zeolite cracking catalysts such as those of the ZSM-5 family. In such case, any conventional FCC catalyst particle components may be used in combination with the NOₓ reduction composition of the invention. If integrated into the FCC catalyst particles the NOₓ reduction composition of the invention preferably represents at least about 0.02 wt. % the FCC catalyst particle, more preferably about 0.1-10 wt. %. Incorporation of the NOₓ reduction composition directly into FCC catalyst particles may be accomplished by any known technique. Examples of suitable techniques for this purpose are disclosed in U.S. Pat. Nos. 3,957,689; 4,499,197; 4,542,188 and 4,458,623, the disclosures of which are incorporated herein by reference.

While the invention is not limited to any particular method of manufacture, the NOₓ reduction composition of the invention is preferably made by the following procedures:

| | | |
|---|---|---|
| (I) | (a) | Spray dry a slurry containing the mixed oxide containing |
| | | ceria and optionally including kaolin as a filler and either a |
| | | silica sol, alumina sol or a silica-alumina sol as a binder |
| | | and a nitrate salt of a Group Ib or Group IIb |
| | (b) | calcine the spray dried microspheres. |
| (II) | (a) | Spray dry a slurry containing the mixed oxide containing |
| | | ceria and optionally including kaolin as a filler and either a |
| | | silica sol, alumina sol or a silica-alumina sol as a binder. |
| | (b) | calcine the spray dried microsphere. |
| | (c) | impregnate the spray dried microspheres with a nitrate salt |
| | | of a Group Ib or Group IIb. |
| | (d) | calcine the impregnated and spray dried microspheres. |
| (III) | (a) | Spray dry a slurry containing the mixed oxide containing |
| | | ceria, a cracking catalyst such as zeolite Y, optionally |
| | | including kaolin as a filler and either a silica sol, alumina |
| | | sol or a silica-alumina sol as a binder. |
| | (b) | add to the slurry of (a) a nitrate salt of a Group Ib or IIb. |
| | (c) | calcine the impregnated, spray dried microspheres. |

Obviously, other alternative methods of manufacture known or suggested to those of ordinary skill in this art can be utilized to form the NOx reducing compositions of this invention.

The compositions of the invention may be used in any conventional FCC process. Typical FCC processes are conducted at reaction temperatures of 450 to 650° C. with catalyst regeneration temperatures of 600 to 850° C. The compositions of the invention may be used in FCC processing of any typical hydrocarbon feedstocks. Preferably, the compositions of the invention are used in FCC processes involving the cracking of hydrocarbon feedstocks which contain above average amounts of nitrogen, especially residual feedstocks or feedstocks having a nitrogen content of at least 0.1 wt. %. The amount of the NOₓ reduction component of the invention used may vary depending on the specific FCC process. Preferably, the amount of NOₓ reduction component used (in the circulating inventory) is about 0.1-15 wt. % based on the weight of the FCC catalyst in the circulating catalyst inventory. The presence of the compositions of the invention during the FCC process catalyst regeneration step dramatically reduces the level of NOₓ emitted during regeneration while having improved hydrothermal stability.

The followings examples are for the purpose of illustrating the invention, and are not to be construed as limiting the invention strictly to the embodiments shown therein.

### EXAMPLE 1

20% Ceria-80% Zirconia

A mixed oxide consisting of 20 wt % ceria and 80 wt % zirconia was pelletized, crushed and sieved to a −40+170 mesh size.

### EXAMPLE 2

20% Ceria-80% Zirconia

An aqueous slurry consisting of 60 wt % of a commercial mixed oxide as in Example 1 and containing 20% ceria-80% zirconia mixed oxide was mixed with 20% kaolin filler and 20% alumina sol binder and spray dried into microspheres. The microspheres were calcined at 1200° F. for 2 h. The final additive composition contained 12 wt % ceria.

### EXAMPLE 3

A slurry consisting of 60 wt % of the commercial mixed oxide composition used in Examples 1 and 2, and 2 wt % of Copper oxide on a salt basis was mixed with 18% kaolin filler and 20% alumina sol binder and spray dried into microspheres. The microspheres were calcined at 1200° F. for 2 h. The final additive composition contained 12 wt % ceria and 2 wt % copper oxide.

### EXAMPLE 4

20% CeO₂/6% La₂O₃/6% Nd₂O₃/68% Zirconia

A mixed oxide consisting of 20 wt % CeO₂, 6 wt % La₂O₃, 6 wt % Nd₂O₃, and 68 wt % Zirconia was pelletized, crushed and sieved to −40+170 mesh size.

### EXAMPLE 5

29.5% CeO₂/0.9% La₂O₃/8% Nd₂O₃/8% Pr₆O₁₁/53.6% Zirconia

A mixed oxide consisting of 29.5 wt % Ceria, 0.9% La₂O₃, 8% Nd₂O₃, 8% Pr₆O₁₁ and balance zirconia was pelletized, crushed and sieved to −40+170 mesh size.

### EXAMPLE 6

70% CeO₂/15% La₂O₃/15% Zirconia

A mixed oxide consisting of 70 wt % Ceria, 15% La₂O₃, and balance zirconia was pelletized, crushed, and sieved to −40+170 mesh size.

### EXAMPLE 7

20% CeO₂/6% La₂O₃/6% Nd₂O₃/68% Zirconia

A mixed oxide consisting of 20 wt % Ceria, 6% La₂O₃, 6 wt % Nd₂O₃ and balance zirconia was pelletized, crushed, and sieved to −40+170 mesh size.

### COMPARATIVE EXAMPLES

### Example A

100% CeO₂

An oxide of cerium was pelletized, crushed, and sieved to −40+170 mesh size.

### Example B

100% Zirconia

An oxide of zirconium was pelletized, crushed, and sieved to −40+170 mesh size.

### EXAMPLE 8

As previously stated, hydrothermal stability is an important property of FCC catalysts and additives. Different methods are known in the art to perform accelerated hydrothermal deactivation of FCC catalysts and additives in the laboratory. The most common procedure for hydrothermal laboratory deactivation is to steam the catalyst or additive in the presence of 100% steam at temperatures ranging from 1300° to 1500° F. for 4 to 8 hours.

The additives as listed in Table 1 below were deactivated by steaming at 1500° F. for 4 hours in 100% steam. Surface areas of fresh and deactivated additives were measured by standard BET method. NO uptakes were measured at room temperature on the additive after reduction in hydrogen at 1000° F. Data from surface area and NO uptake tests are shown below in Table 1. Surface area retention is the percentage of the surface area retained after steaming. NO uptake retention is the percentage of the NO uptake capacity retained after steaming.

TABLE 1

| | | | SA retention, | NO retention, |
|---|---|---|---|---|
| | | | % | % |
| | NO uptake × 10⁵ | SA, | (As is - | (As is - |
| | Mol/g | m2/g | steamed) | steamed) |
| Example A | 23.3 | 155 | 7 | 13 |
| Example B | 0.0 | 102 | 12 | N.A. |
| Example 1 | 25.1 | 51.1 | 56 | 59 |
| Example 4 | 29.5 | 64.2 | 56 | 69 |
| Example 5 | 26.4 | 59.7 | 71 | 63 |
| Example 6 | 56.1 | 90.0 | 48 | 57 |
| Example 7 | 29.5 | 83.5 | 72 | 69 |

As can be seen, Examples 1 and 4 through 7, within the scope of the present invention, yielded substantial NO uptake retention and surface area stability relative to Comparative Examples A and B. The results of the testing are particularly unexpected in that zirconia oxide alone yielded little NO uptake of steamed materials.

1. A NOₓ removal composition suitable for reducing NOₓ emissions during catalyst regeneration in a fluid catalytic cracking process, said composition comprising a microsphere having an average size of from about 20 to 200 microns and composed of (i) a mixed oxide of cerium and zirconium, (ii) optionally, an oxide from the lanthanide series other than ceria, and (iii) optionally, at least one oxide of a transition metal selected from Groups Ib and IIb of the Periodic Table and mixtures thereof.

2. The composition of claim 1 wherein the oxide other than ceria is selected from oxides of La, Nd, Pr, or mixtures thereof.

3. The composition of claim 1 wherein said microsphere is 50 to 100 microns.

4. The composition of claim 1 wherein the mixed oxide (i) contains at least 20% cerium oxide by weight.

5. The composition of claim 1 wherein the mixed oxide (i) contains at least 15 wt % zirconia.

6. The composition of claim 1 wherein said Group Ib and IIb transition metals (iii) are selected from the group consisting of copper, silver, zinc and mixtures thereof.

7. The composition of claim 1 wherein said mixed oxide (i) contains at least 20 % cerium oxide by weight and at least 15% zirconium oxide by weight.

8. The composition of claim 7 wherein said mixed oxide (i) is present in amounts of at least 70% by weight relative to the total of (i), (ii), and (iii).

9. The composition of claim 1 including positive amounts of component (iii).

10. The composition of claim 9 wherein said at least one oxide of a transition metal (iii) is copper oxide.

11. The composition of claim 1 further including (iv) a zeolitic cracking catalyst.

12. The composition of claim 11 wherein said zeolitic cracking catalyst is a synthetic faujasite or ZSM-5.

13. The composition of claim 1 further including separate catalyst particles, said separate catalyst particles comprising a zeolitic cracking catalyst.

14. The composition of claim 13 wherein said zeolitic cracking catalyst comprises a synthetic faujasite of zeolite Y or X, or ZSM-5.

15. The composition of claim 1 wherein components (i), (ii), and (iii) comprise at least 40 weight % of said NOx removal composition.

16. The composition of claim 1 wherein components (i), (ii), and (iii) comprise at least 55 weight % of said NOx removal composition.

17. A method of reducing NOₓ emission during fluid catalytic cracking of a hydrocarbon feedstock into lower molecular weight components said method comprising contacting a hydrocarbon feedstock with a cracking catalyst suitable for catalyzing the cracking of hydrocarbons at elevated temperature whereby lower molecular weight hydrocarbon components are formed in the presence of a NOₓ reduction composition, wherein said NOₓ reduction composition comprises a (i) mixed oxide of cerium and zirconium, (ii) optionally, at least one oxide from the lanthanide series other than cerium and (iii) optionally, an oxide of a transition metal selected from Groups Ib and IIb of the Periodic Table, said NOₓ reduction component being present in a sufficient NOₓ reducing amount.

18. The method of claim 17 wherein said cracking catalyst and NOx reduction composition are separate particles.

19. The method of claim 17 wherein said cracking catalyst and NOx reduction composition are present as an integral combination of the cracking catalyst component and the NOx reduction composition component in a single particle.

20. The method of claim 17 wherein said cracking catalyst is fluidized during contact with a hydrocarbon feedstock.

21. The method of claim 17 further comprising recovering used cracking catalyst from said contacting step and treating said used catalyst under conditions to regenerate said catalyst.

22. The method of claim 17 wherein said hydrocarbon feedstock contains at least 0.1 wt % nitrogen.

23. The method of claim 17 wherein said mixed oxide (i) contains at least 20% cerium oxide by weight and at least 15% zirconium oxide by weight.

24. The method of claim 17 wherein said NOx reduction component includes positive amounts of component (iii).

25. The method of claim 24 wherein said at least one oxide of a transition metal (iii) is copper oxide.

26. The method of claim 17 wherein said NOx reduction component includes positive amounts of component (ii).

27. The method of claim 26 wherein (ii) comprises oxides of La, Nd, Pr, or mixtures thereof.

28. The method of claim 18 wherein components (i), (ii), and (iii) comprise at least 40 weight % of said NOx removal composition.

29. The method of claim 18 wherein components (i), (ii), and (iii) comprise at least 55 weight % of said NOx removal composition.

30. The composition of claim 23 wherein said mixed oxide (i) is present in amounts of at least 70% by weight relative to the total of (i), (ii), and (iii).
